(19) United States
(12) Patent Application Publication
(10) Pub. No.: US 2015/0329803 A1
(43) Pub. Date: Nov. 19, 2015

(54) Homogeneous Detergent Composition

(71) Applicant: BASF CORPORATION, Florham Park, NJ (US)

(72) Inventors: Christopher C. Caires, Birmingham, MI (US); Rebecca L. Miller, Madison Heights, MI (US)

(21) Appl. No.: 14/758,831

(22) PCT Filed: Jan. 3, 2014
(86) PCT No.: PCT/US2014/010184

§ 371 Date: Jul. 1, 2015

Related U.S. Application Data
(60) Provisional application No. 61/748,687, filed on Jan. 3, 2013.

(51) Int. Cl. C11D 3/37; C11D 17/04; C11D 3/10

(52) U.S. Cl. CPC C11D 3/3757; C11D 3/10; C11D 17/042

(57) ABSTRACT

A homogeneous detergent composition includes an alkalinity builder in an amount of at least about 35 parts by weight based on 100 parts by weight of the homogeneous detergent composition. The homogeneous detergent composition also includes a polycarboxylate for dispersing the alkalinity builder, and a solvent for further dispersing the alkalinity binder. The solvent is present in an amount of from about 20 to about 45 parts by weight based on 100 parts by weight of the homogeneous detergent composition. The homogeneous detergent composition has a viscosity of at least about 15,000 cPs at 25° C.

### CROSS REFERENCE TO RELATED APPLICATIONS

This application claims the benefit of U.S. Provisional Patent Application Ser. No. 61/748,687, filed on Jan. 3, 2013, which is incorporated herewith by reference in its entirety.

### FIELD OF THE INVENTION

The present disclosure generally relates to a homogeneous detergent formulation. More specifically, the present disclosure relates to a homogeneous detergent composition comprising an alkalinity builder, a polycarboxylate, and a solvent and to a detergent packet comprising the homogeneous detergent composition disposed therein.

### DESCRIPTION OF THE RELATED ART

Detergent compositions for automatic dishwashing machines are understood in the art. Typically, detergent compositions are dispensed directly as granular solids or free flowing liquids. However, many consumers prefer to avoid contact with granular solids and free flowing liquids for a variety of reasons which include: general dislike of storing spillable chemicals, desire for a more controllable medium, safety concerns, etc. One way to avoid the use of granular solids or free flowing liquids is to create a viscous gel. However, due to the amount of solid raw materials that are incorporated into conventional detergent compositions, such viscous gels require a considerable amount of solvent which is undesirable.

Another way to avoid the use of granular solids or free flowing liquids is to incorporate the detergent composition into a water soluble packet. However, because the packet itself is water soluble, the detergent compositions can not contain large quantities of solvent, e.g. water, otherwise the packet will dissolve. As such, the detergent compositions provided in water soluble packets are a combination of solid raw materials and liquid raw materials and are not a homogeneous mixture. The solid and liquid raw materials are not directly homogenized before being placed into the packet, because the resulting mixture is neither stable nor dispensable. Furthermore, it is often necessary to segregate the liquid raw materials from the solid raw materials thereby increasing complexity and cost of the water soluble packet. Moreover, the expense of placing both the solid and liquid raw materials in the packet increases the cost to produce the packet.

Accordingly, there remains an opportunity to create a high solids homogeneous detergent composition that is stable and capable of being dispensed into a water soluble packet while not adversely affecting the water soluble packet.

### SUMMARY OF THE INVENTION AND ADVANTAGES

The present disclosure provides a homogeneous detergent composition. The homogeneous detergent composition comprises an alkalinity builder. The alkalinity builder is present in an amount of at least about 35 parts by weight based on 100 parts by weight of the homogeneous detergent composition. The homogeneous detergent composition also comprises a polycarboxylate for dispersing the alkalinity builder. The homogeneous detergent composition further comprises a solvent for further dispersing the alkalinity binder. The solvent is present in an amount of from about 20 to about 45 parts by weight based on 100 parts by weight of the homogeneous detergent composition. The homogeneous detergent composition has a viscosity of at least about 15,000 cPs at 25° C.

The homogeneous detergent composition has excellent flow and stability despite being high in solid content, which is generally imparted by the alkalinity builder. Flow properties of the homogeneous detergent composition are ideal for dispensing the homogeneous detergent composition into water soluble packets. Moreover, because the homogeneous detergent composition is homogeneous and high in solid content, the water soluble packet is not adversely affected by the homogeneous detergent composition.

### BRIEF DESCRIPTION OF THE DRAWINGS

Advantages of the present disclosure will be readily appreciated, as the same becomes better understood by reference to the following detailed description, when considered in connection with the accompanying drawings.

FIG. 1A is a scatter plot of multiple embodiments of the homogeneous detergent composition illustrating the viscosity of the homogeneous detergent composition at 25° C. as a function of time.

FIG. 1B is a scatter plot of multiple embodiments of the homogeneous detergent composition illustrating the viscosity of the homogeneous detergent composition at 40° C. as a function of time.

FIG. 2 is a scatter plot of multiple embodiments of the homogeneous detergent composition illustrating the viscosity of the homogeneous detergent composition as a function of time and temperature.

FIG. 3 is a box and whisker plot of multiple embodiments of the homogeneous detergent composition illustrating the detergency of the homogeneous detergent composition.

### DETAILED DESCRIPTION OF THE INVENTION

The present disclosure provides a homogeneous detergent composition. The homogeneous detergent composition can be used for a variety of purposes and is especially useful for use in automatic dishwashing machines. Typically, the homogeneous detergent composition is used to clean and/or sanitize dishware, cookware, pots, pans, cutlery, dishes, cup, glasses, bowls, saucers, and the like.

The homogeneous detergent composition may be used to clean and/or sanitize a variety of surfaces, including, but not limited to, a hard, non-porous, semi-porous, or partially porous surface. The surface may be soiled with stains including, but not limited to, greasy stains, inorganic stains, organic stains, egg stains, oatmeal stains, protein stains, carbohydrate stains, starch stains, stains resulting from animal fats, soap scums, stains resulting from scale/lime deposits, rust, corrosion and oxidation, minerals, and water spots, stains resulting from ink, mold, yeast, blood, grass, mustard, coffee, tea, alcohol, lipstick and make-up, cooking oils, adhesive residue, and combinations thereof.

The homogeneous detergent composition typically has excellent cleaning properties. Some of these properties include one or more of the following: tying-up/inactivating hard minerals, such as calcium and magnesium; reducing surface tension of water to allow water to penetrate and loosen soil, such as food soil; suspending and/or dispersing removed soils in water; saponifying oily/fatty soils, enzymatically digesting protein-based soils; removing proteinaceous and starchy soils; suppressing foam caused by protein soils, such as eggs and milk; lowering surface and interfacial tensions of water; protecting china patterns and metals from the corrosive effects of heat and water; and neutralizing acidic soils.

In various embodiments, the homogeneous detergent composition has one or more excellent cleaning properties that may include one or more of the properties described immediately below. Detergency is a cleaning property that includes the ability to break the bond between soil and a surface. Penetration and wetting are cleaning properties which allow water to surround soil particles that would otherwise repel the water. Emulsification is a cleaning property that includes the ability to break up oil based soils into small droplets that can be dispersed thoroughly. Solubilizing is a cleaning property that dissolves soil such that the soil is no longer a solid particle. Dispersing is a cleaning property which leads to spreading small soil particles throughout a solution (e.g. wash water) to prevent the soil particles from sticking to objects such as dishwasher racks, dishwasher walls, or back onto a cleaned surface (e.g. dishes, glasses and tableware).

The homogeneous detergent compositions can also be useful for helping water to sheet off the surface, thus minimizing water spots and filming on the surface. Films are typically formed on tableware and glassware upon evaporation of water containing solids. Solids in wash water can originate from soil load and/or soils present on tableware, glassware, etc. Typical soils include proteinaceous, fatty and starch-based soils. Water hardness contributes to the presence of solids typically in the form of insoluble calcium and magnesium salts. Water temperature can also affect the cleaning performance of the homogeneous detergent compositions, with increased temperature typically increasing cleaning performance of the homogeneous detergent compositions.

By “homogeneous”, it is generally meant that the homogeneous detergent composition appears uniform to the naked eye after mixing. For example, if an aliquot of the homogeneous detergent composition was partitioned into a first and second portion, the first portion would be essentially identical in appearance and chemical composition to the second portion. However, it is to be appreciated that an observer viewing the homogeneous detergent composition through a magnification device (e.g. a microscope) may be able to discern discrete physical particles, mixing lines, etc.

The homogeneous detergent composition comprises an alkalinity builder. The alkalinity builder is present in an amount of at least about 35 parts by weight based on 100 parts by weight of the homogeneous detergent composition. The homogeneous detergent composition further comprises a polycarboxylate for dispersing the alkalinity builder. The homogeneous detergent composition also comprises a solvent for further dispersing the alkalinity binder. The solvent is present in an amount of from about 20 to about 45 parts by weight based on 100 parts by weight of the homogeneous detergent composition. The homogeneous detergent composition has a viscosity of at least about 15,000 cPs at 25° C.

Referring to the alkalinity builder, the alkalinity builder can be any material capable of producing an alkaline environment. It is to be appreciated that the alkalinity builder may include one or more materials for building alkalinity. In other words, the alkalinity builder is not limited to a single raw material for building alkalinity.

In certain embodiments, the alkalinity builder includes a metal carbonate. The metal may be any alkali metal or alkaline earth metal. In a specific embodiment, the alkalinity builder comprises sodium carbonate. Sodium carbonate is also commonly referred to in the art as “soda ash,” especially when in an anhydrous form, or as “washing soda” when in a hydrated/crystalline form. Because metal carbonates are generally strong alkaline salts, the metal carbonates are useful as components in the alkalinity builder or as the sole component of the alkalinity builder. The metal carbonate provides alkaline cleaning power and also typically softens water by precipitating the hardness minerals out of solution. Besides building alkalinity, sodium carbonate tends to soften water by converting hardness minerals to insoluble forms in contrast to softening by sequestration, i.e., without precipitation. The metal carbonate is also useful for breaking down and helping to remove proteinaceous and starchy soils from surfaces, such as those described above. Suitable grades of metal carbonates are commercially available from a variety of suppliers.

In other embodiments, the alkalinity builder includes metal silicate, and/or a metal citrate. Typically, the metal is sodium (Na) or potassium (K). However, the metal is not limited and may alternatively include a transition metal. In a specific embodiment, the alkalinity builder is sodium citrate. In another specific embodiment, the alkalinity builder comprises both sodium citrate and sodium carbonate. The metal citrate is typically a metal (e.g. Na or K) salt of citric acid. As such, the metal citrate may include some amount of citric acid itself, such as trace amounts of citric acid. It is to be appreciated that citric acid may also be used as an additional component in the homogeneous detergent composition.

In other related embodiments, the alkalinity builder can include one or more of sodium silicate (also known as sodium metasilicate), and sodium carbonate, and sodium citrate. Examples of additional non-limiting compounds that can be utilized include sodium bicarbonate, sodium aluminosilicate, and combinations thereof.

In various embodiments, the alkalinity builder is present in an amount of from about 35 to about 80, about 35 to about 60, about 35 to about 50, or about 40 to about 45, parts by weight, each based on 100 parts by weight of the homogeneous detergent composition. The amount of the alkalinity builder is not limited to those amounts described above and may include any amount or range of amounts within or between those amounts described above.

Referring now to the polycarboxylate, the polycarboxylate is useful for dispersing the alkalinity builder in the homogeneous detergent composition. In addition to dispersing the alkalinity builder in the homogeneous detergent composition, the polycarboxylate may keep particles of soil that have been removed from wares in a dispersed or suspended state such that the particles are more readily removed from the dishwasher when the wash water is pumped out from the dishwasher.

Generally, the polycarboxylate is a polymer which contains carboxylic acid groups or a salt thereof. Various polycarboxylates can be utilized to disperse the alkalinity builder in the homogeneous detergent composition.

In certain embodiments, the polycarboxylate is the polymerization product of at least two monomers selected from the group of a sulfonic acid acrylate, acrylic acid, methacrylic acid, maleic acid, an allyl ether, diisobutene, isopropyl alcohol, and an ionic monomer of the Formula (I):

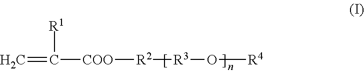

In Formula (I) above, R¹ is either hydrogen or a methyl group. R² is either a linear or branched C1-C6 alkylene. Each R³ can be the same or different. Each R³ is a linear or branched C2-C4 alkylene radical. R⁴ is a linear or branched C1-C6 alkyl. The number of repeat units, n, is an integer of from 3 to 50.

It is to be appreciated that polycarboxylate may be polymerized from only one type of monomer. In other words, the polycarboxylate is not limited to two different monomers. For example, in one embodiment, the polycarboxylate is the polymerization product of the sulfonic acid acrylate. In another example, the polycarboxylate is the polymerization product of diisobutene.

In one embodiment, the polycarboxylate is the polymerization product of a sulfonic acid acrylate and acrylic acid. Various sulfonic acid acrylates can be polymerized with acrylic acid. In one embodiment, the sulfonic acid acrylate is 2-acrylamido-2-methylpropane sulfonate. In a specific embodiment, the polycarboxylate is a copolymer of acrylic acid and 2-acrylamido-2-methylpropane sulfonate.

In another embodiment, the polycarboxylate is the polymerization product of acrylic acid, maleic acid, and an allyl ether. In certain embodiments, the allyl ether is polyethylene glycol allyl ether. In one embodiment, the polycarboxylate is a copolymer of acrylic acid, maleic acid, and an allyl ether. In another embodiment, the polycarboxylate is a copolymer of acrylic acid, maleic acid, and polyethylene glycol allyl ether.

In another embodiment, the polycarboxylate is the polymerization product of acrylic acid, and isopropyl alcohol. Without being held to any particular theory, it is believed the isopropyl alcohol reacts with acrylic acid to produce a polycarboxylate with lactone functionality. Various amounts of the isopropyl alcohol can be polymerized with acrylic acid to produce the polycarboxylate. In one specific embodiment, the polycarboxylate is a copolymer of acrylic acid and isopropyl alcohol.

In another embodiment, the polycarboxylate is the polymerization product of acrylic acid, methacrylic acid, and the ionic monomer of Formula (I). In one specific embodiment, the polycarboxylate is a copolymer of acrylic acid, methacrylic acid, and the ionic monomer of Formula (I).

In certain embodiments, the polycarboxylate is the polymerization product of acrylic acid and maleic acid. In these embodiments, the polycarboxylate generally has a weight average molecular weight of from about 30,000 to about 120,000, about 45,000 to about 105,000, about 60,000 to about 90,000, or about 65,000 to about 75,000, g/mol.

In certain embodiments, the polycarboxylate is the polymerization product of maleic acid and diisobutene. In these embodiments, the polycarboxylate generally has a weight average molecular weight of from about 6,000 to about 20,000, about 8,000 to about 18,000, about 10,000 to about 16,000, or about 12,000 to about 14,000, g/mol.

In certain embodiments, the polycarboxylate is the polymerization product of acrylic acid. In these embodiments, the polycarboxylate generally has a weight average molecular weight of from about 2,000 to about 20,000, about 3,000 to about 15,000, about 4,000 to about 10,000, about 5,000 to about 9,000, or about 6,000 to about 8,000, g/mol.

In other embodiments the polycarboxylates are commercially available from BASF Corporation of Florham Park, N.J., under the trade names of SOKALAN® CP 50, SOKALAN® CP 44, SOKALAN® CP 10, SOKALAN® CP 42, SOKALAN® CP 5, SOKALAN® CP 9, SOKALAN® PA 25 CL, and SOKALAN® PA 30 CL.

In various embodiments, the polycarboxylate is a solid. In further embodiments, the polycarboxylate is a granule. In yet a further embodiment, the polycarboxylate is supplied in a solvent. The present disclosure is not limited to the manner in which the polycarboxylate is supplied. For example, the polycarboxylate can be incorporated into the homogeneous detergent mixture as a solid or dissolved in a solvent or dispersed in a solvent or suspended in a solvent or in the form of a swollen polycarboxylate.

In various embodiments, the polycarboxylate is present in an amount of from about 0.01 to about 40, about 0.1 to about 30, about 1 to about 15, about 1.5 to about 10, about 2 to about 5, or about 2.5 to about 4, parts by weight, each based on 100 parts by weight of the homogeneous detergent composition. In certain embodiments, the polymeric component is present in an amount of from about 2 to about 4 parts by weight based on 100 parts by weight of the homogeneous detergent composition. The amount of the polycarboxylate is not limited to those amounts described above and may include any amount or range of amounts within or between those amounts described above.

Referring now to the solvent, the solvent is useful for further dispersing the alkalinity builder in the homogeneous detergent composition. Various types of solvents can be used to disperse the alkalinity builder. In certain embodiments, the solvent is water. In other embodiments, the solvent is not water but is water miscible. In certain embodiments, the solvent is glycerine. It is to be appreciated that the homogeneous detergent composition can comprise more than one solvent. In certain embodiments, the solvent comprises water and glycerine.

The solvent may be added to the homogeneous detergent composition by directly adding solvent or indirectly adding solvent by also adding an additive that contains solvent. In other words, the total amount of solvent included in the homogeneous detergent composition is the amount of solvent directly added to the homogenous detergent composition and the amount of solvent contained within the additives (or other raw materials) added the homogeneous detergent composition. For example, if 20 parts by weight of glycerine are added and 10 parts by weight of an additive comprising 50% by weight of water are added, the total solvent in this example would be 25 parts by weight, which includes the 20 parts by weight of glycerine and the 5 parts by weight of water that is introduced via the additive.

In various embodiments, the solvent is present in an amount of from about 20 to about 45, about 23 to about 42, about 26 to about 39, about 29 to about 36, or about 32 to about 33, parts by weight, each based on 100 parts by weight of the homogeneous detergent composition. In certain embodiments, the homogeneous detergent composition comprises from about 10 to about 25 parts by weight of glycerin and from about 10 to about 20 parts by weight of water, each based on 100 parts by weight of the homogeneous detergent composition. In further embodiments, the homogeneous detergent composition comprises from about 17 to about 20 parts by weight of glycerin and from about 7 to about 13 parts by weight of water, each based on 100 parts by weight of the homogeneous detergent composition. The amount of the solvent is not limited to those amounts described above and may include any amount or range of amounts within or between those amounts described above.

The homogeneous detergent composition has a viscosity of at least about 15,000 cPs at 25° C. at a shear rate of 100 sec⁻¹. In various embodiments, the homogeneous detergent composition has a viscosity of from about 19,000 to about 750,000, about 50,000 to about 400,000, about 90,000 to about 250,000, about 110,000 to about 220,000, about 130,000 to about 200,000, or about 150,000 to about 170,000, cPs at 25° C. when measured at a shear rate of 100 sec⁻¹. The viscosity of the homogeneous detergent composition is not limited to those values or range of values described above and may include any value or range of values within or between those described above.

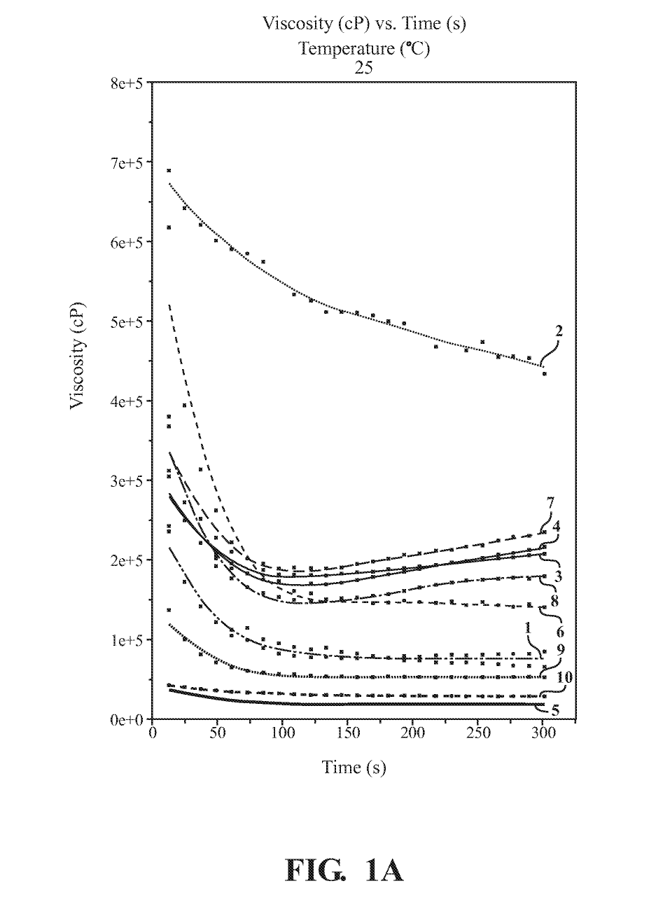

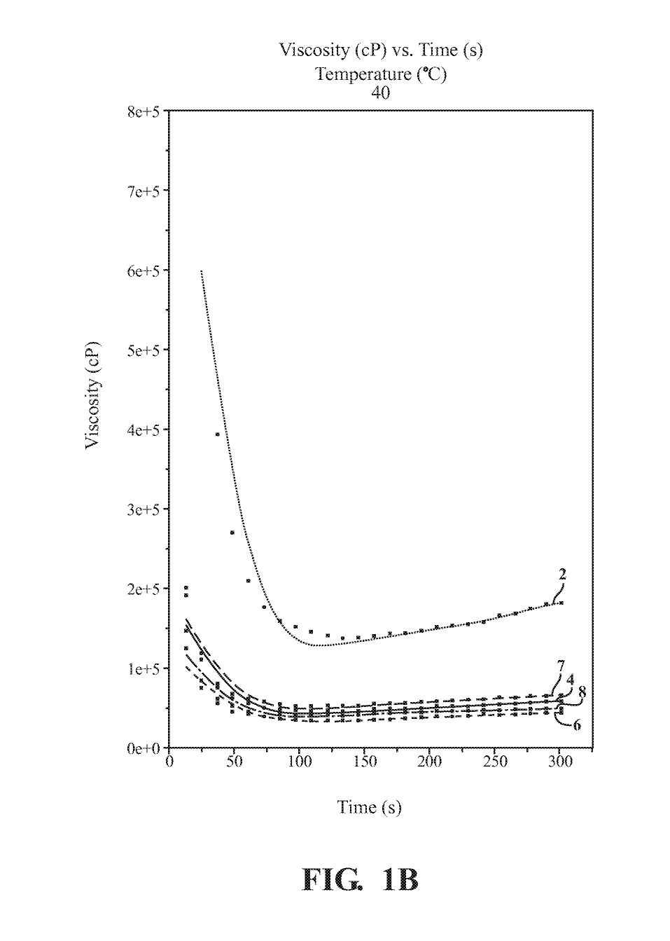

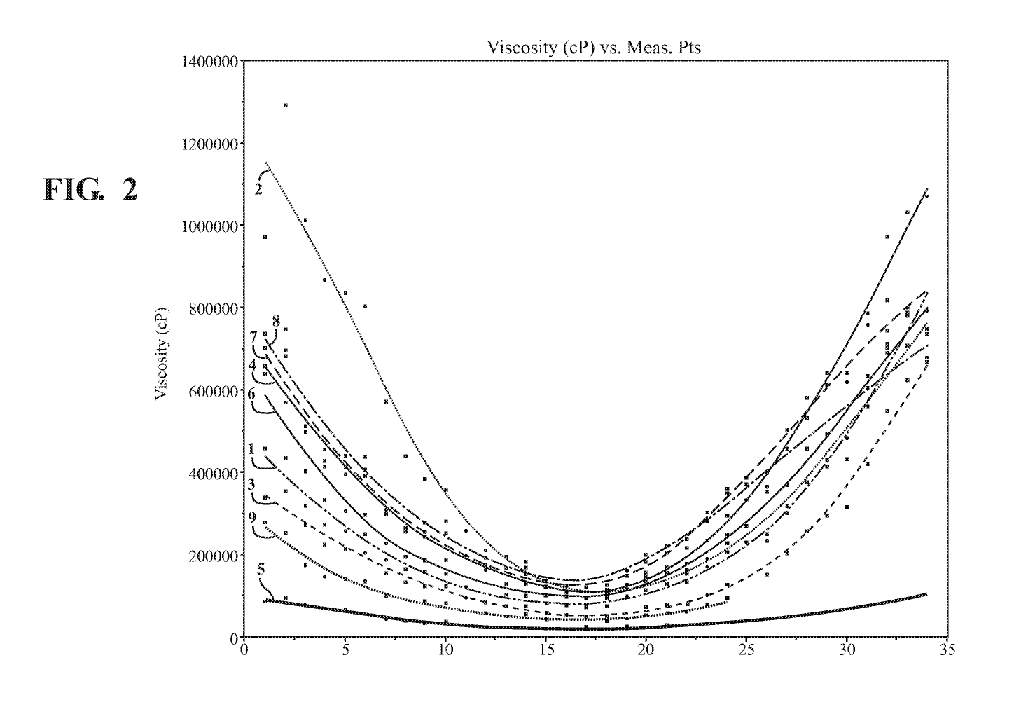

As shown in FIGS. 1A, 1B, and 2, which are described further in the Examples section, the homogeneous detergent composition generally has thixotropic and non-Newtonian flow properties. As also shown in FIGS. 1A, 1B, and 2, the viscosity of the homogeneous detergent composition is typically temperature dependent. In some embodiments, the homogeneous detergent composition exhibits strong shear thinning flow behavior at low shear rates. In other words, in some embodiments when a low shear rate is applied to the homogeneous detergent composition, the viscosity of the homogeneous detergent composition decreases and the homogeneous detergent composition begins to flow. In other embodiments, the viscosity of the homogeneous detergent composition exhibits strong temperature dependence. More specifically, the homogeneous detergent composition's viscosity decreases significantly with small increases in temperature. In yet another embodiment, the viscosity of the homogeneous detergent composition decreases continuously with a constant shear stress, i.e., the homogeneous detergent composition is thixotropic. The rheological properties of the homogeneous detergent composition are desirable because it facilitates the production process. More specifically, after a batch of homogeneous detergent composition is made in a production process the viscosity is high. Traditionally, highly viscous liquids are difficult to manipulate and dispense into small packages. The homogeneous detergent composition can be thinned by various mechanisms (e.g. such as temperature, low shear rates, and continuous shear) and easily dispensed into small packages, due to the thixotropy, non-Newtonian flow properties, and temperature dependence of the homogeneous detergent composition. For example, the homogeneous detergent composition can be thinned to a readily pourable and/or injectable viscosity with a relatively low shear rate. Alternatively, the homogeneous composition can be thinned by a slight increase in temperature, e.g. an increase from 25 to 40° C.

The homogeneous detergent composition generally disperses in water. For, example at temperatures typically encountered in a dishwashing environment (e.g. 35° C. or higher) the homogeneous detergent readily disperses. The homogeneous detergent composition can also disperse at temperatures below a dishwashing environment.

The homogeneous detergent composition may also comprise a chelating agent. The chelating agent is typically a polyaminocarboxylic acid or salt thereof selected from the group of methylglycine diacetic acid (MGDA), nitrilotriacetic acid (NTA), glycinediacetic acid (GLDA), ethylene diamine tetraacetic acid (EDTA), iminodisuccinimide (IDS), and combinations thereof. Typically the salt is an alkali salt, such as sodium salt. The chelating agent may include one or more of MGDA, GLDA, EDTA, IDS and may include combinations thereof.

As used hereinafter, the acronym MGDA is generally meant to include either MGDA, or an alkali salt of MGDA, (e.g. Na₃.MGDA), or mixtures thereof. Likewise, the acronym GLDA is generally meant to include either GLDA, or an alkali salt of GLDA.

In one embodiment, the chelating agent is aqueous, such that the chelating agent is supplied in an aqueous medium, e.g. water. In other embodiments, the chelating agent is supplied in the form of an anhydrous powder. In various embodiments, the chelating agent includes MGDA such that the MGDA is present in the chelating agent in amounts of from about 35 to about 95, of from about 35 to about 85, or of about 35 to about 45, or of about 40, parts by weight, each based on 100 parts by weight of the chelating agent. In other embodiments, the chelating agent is the powder form of GLDA and is present in similar amounts as described above for MGDA. The chelating component may also be in the form of a gel.

The chelating agent is useful for inactivating hard minerals and/or metallic ions in water, such as water encountered in conventional residential, commercial, industrial and institutional dishwashers. Hardness of water is generally imparted to the water by minerals, such as calcium and magnesium. Other metallic ions include dissolved metals, such as iron and manganese.

Typically, MGDA and GLDA inactivate hard minerals (e.g. calcium and magnesium) and iron and manganese without precipitation. Water softening without precipitation, i.e., by sequestration, distinguishes MGDA and GLDA from other compounds such as sodium carbonate, which generally soften by precipitation of the hard minerals. MGDA and GLDA generally combine with hardness minerals and hold them in solution such that the hardness minerals cannot combine with (food) soils. In addition, neither the hardness minerals themselves nor the hardness mineral/soil combination typically leave insoluble spots or film on tableware, glassware, and the like.

Without being bound or limited by any particular theory, it is believed that the low molecular weight of MGDA imparts MGDA with greater chelating/sequestering efficiency relative to other chelating agents or components, such as GLDA. Those skilled in the art can appreciate that MGDA and GLDA are both generally classified as aminocarboxylates. It is to be appreciated that the homogeneous detergent composition is not limited solely to the use of MGDA and/or GLDA, and may include one or more chelating agents in addition to MGDA and/or GLDA.

Non-limiting examples of suitable chelating agents are commercially available from BASF Corporation under the trade name TRILON® M, such as TRILON® M liquid, TRILON® M powder, TRILON® A, and TRILON® B. Further non-limiting examples of suitable (A) chelating components are commercially available from AkzoNobel of Chicago, Ill., under the trade name DISSOLVINE® GL. Other non-limiting examples of suitable chelating agents are described in U.S. Pat. No. 5,786,313 to Schneider et al. and in U.S. Pat. App. Pub. No. 2009/0105114 to Stolte et al., the disclosures of which are incorporated herein by reference in their entirety to the extent that the disclosures do not conflict with the general scope of the present disclosure described herein.

In various embodiments, the chelating agent is present in an amount of from 0 to about 45, about 5 to about 40, about 10 to about 30, about 12 to about 28, about 14 to about 26, about 16 to about 24, or about 18 to about 22, parts by weight, each based on 100 parts by weight of the homogeneous detergent composition. In certain embodiments, the chelating agent is present in an amount of from about 17 to about 19 parts by weight based on 100 parts by weight of the homogeneous detergent composition. The chelating agent is not limited to those amounts described above and may include any amount or range of amounts within or between those amounts described above.

Additives that can be Included in the Homogeneous Detergent Composition:

The homogeneous detergent composition may include one or more additives, such as supplemental builder components, bleaches, enzymes, salts, graying inhibitors, soil release polymers, color transfer inhibitors, foam inhibitors, complexing agents, optical brighteners, fragrances, fillers, inorganic extenders, formulation auxiliaries, solubility improvers, opacifiers, dyes, corrosion inhibitors, peroxide stabilizers, electrolytes, soaps, detergents, acids such as phosphoric acid, amidosulfonic acid, citric acid, lactic acid, acetic acid, peracids, and trichloroisocyanuric acid, chelating agents such as perfumes, oils, oxidizing agents such as perborates, dichloroisocyanurates, enzymes, interface-active ethyleneoxy adducts, surfactants, and combinations thereof.

The homogeneous detergent composition may comprise a surfactant. In one embodiment, the homogeneous detergent composition comprises a nonionic surfactant. Examples of nonionic surfactants include, but are not limited to, alkylphenol alkoxylates, alcohol alkoxylate, alkyl polyglucosides, hydroxyalkyl polyglucosides, hydroxyl mixed ether, N-alkylglucamides, alkylene oxide block copolymers, polyhydroxy and polyalkoxy fatty acid derivatives, and combinations thereof.

In various embodiments, the nonionic surfactant is present in the homogeneous detergent composition in an amount of from about 0.1 to about 10, about 0.3 to about 9, about 0.5 to about 8, about 0.7 to about 7, about 0.9 to about 6, about 1.1 to about 5, about 1.3 to about 4, about 1.5 to about 3, or about 1.7 to about 2, parts by weight, each based on 100 parts by weight of the homogeneous detergent composition. The amount of the surfactant is not limited to those amounts described above and may include any amount or range of amounts within or between those amounts described above.

The homogeneous detergent composition may include an enzyme. The enzyme may include proteases such as SAVINASE® and ESPERASE®, lipases such as LIPOLASE®, cellulases such as CELLUZYME®, and combinations thereof. Each of the SAVINASE®, ESPERASE®, LIPOLASE®, and CELLUZYME® are commercially available from Novo Nordisk of Princeton, N.J. The enzyme may alternatively include an amylase, a lipase, a cellulase, or a peroxidase, or combinations thereof. The enzyme may break down soils, break down proteins into smaller and less complex molecules, and/or break down carbohydrates. In one embodiment, the chelating agent has excellent compatibility with the enzyme, which increases performance of the builder and/or detergent compositions. Additional non-limiting examples of suitable enzymes are commercially available from Danisco A/S of Copenhagen, Denmark, under the trade name PROPERASE®, such as PROPERASE® L, and under the trade name PURASTAR®, such as PURASTAR® HP Am. In one embodiment the enzyme is comprises protease and amylase. In a specific embodiment the enzyme is commercially under the trade name TWINPOWER®.

In various embodiments, the enzyme is present in the homogeneous detergent composition in an amount of from about 0.01 to about 10, about 0.1 to about 5, about 0.5 to about 3, or about 2, parts by weight, each based on 100 parts by weight of the homogeneous detergent composition. The amount of the enzyme is not limited to those amounts described above and may include any amount or range of amounts within or between those amounts described above.

The homogeneous detergent composition may include a corrosion inhibitor. Various corrosion inhibitors can be used in the homogeneous detergent composition. In one embodiment, the corrosion inhibitor comprises sodium silicate. In other embodiments, the corrosion inhibitor comprises sodium metasilicate. These inhibitors can provide protection of metal components of the washer by acting as a lubricant and can provide protection for china patterns and metal tableware/utensils. Another example of a suitable corrosion inhibitor is zinc sulfate. Examples of suitable supplemental corrosion inhibitors are commercially available from BASF Corporation and Fisher Scientific of Pittsburgh, Pa.

In various embodiments, the corrosion inhibitor is present in the homogeneous detergent composition in an amount of from about 1 to about 45, about 3 to about 20, or about 5 to about 10, parts by weight, each based on 100 parts by weight of the homogeneous detergent composition. In one embodiment, the corrosion inhibitor is present in an amount of from about 6 to 8 parts by weight, based on 100 parts by weight of the homogeneous detergent composition. The homogeneous detergent composition may include a combination of two or more corrosion inhibitors. In some embodiments, the corrosion inhibitor may be suspended in solvent prior to incorporating the corrosion inhibitor in the homogeneous detergent composition. The amount of the corrosion inhibitor is not limited to those amounts described above and may include any amount or range of amounts within or between those amounts described above.

The homogeneous detergent composition may include a bleach. The bleach may include, but is not limited to, alkali metal perborates, alkali metal carbonate perhydrates, peracids, and combinations thereof. Suitable examples of peracids include, but are not limited to, peracetic acid, C₁-C₁₂ percarboxylic acids, C₈-C₁₆ dipercarboxylic acids, imidopercaproic acids, aryldipercaproic acids, linear and branched octane-, nonane-, decane- or dodecane-monoperacids, decane- and dodecane-diperacid, mono- and di-perphthalic acids, isophthalic acids and terephthalic acids, phthalimidopercaproic acid, terephthaloyldipercaproic acid, polymeric peracids, salts thereof, and combinations thereof. The bleach may be present in the homogeneous detergent composition in any amount. In one embodiment, the bleach is present in the homogeneous detergent composition in an amount of from about 0.5 to about 30% by weight.

In a specific embodiment, the homogeneous detergent composition comprises an alkalinity builder. The alkalinity builder comprises sodium carbonate and is present in an amount of at least about 35 parts by weight based on 100 parts by weight of the homogeneous detergent composition. The homogeneous detergent composition also comprises a polycarboxylate for dispersing the alkalinity builder, the polycarboxylate is selected from the group of: a polymerization product of acrylic acid and having a weight average molecular weight of from about 2,000 to about 20,000; a polymerization product of a sulfonic acid acrylate and acrylic acid; a polymerization product of acrylic acid, maleic acid, and an allyl ether; a polymerization product of acrylic acid and isopropyl alcohol; a polymerization product of maleic acid and diisobutene, and a polymerization product of acrylic acid, methacrylic acid, and an ionic monomer of the Formula I. The homogeneous detergent composition further comprises a solvent for further dispersing the alkalinity binder. The solvent comprises water, glycerine, or a combination thereof and is present in an amount of from about 20 to about 45 parts by weight based on 100 parts by weight of the homogeneous detergent composition. The homogeneous detergent composition further comprises a chelating agent present in an amount of from about 1 to about 45 parts by weight based on 100 parts by weight of the homogeneous detergent composition. The chelating agent comprising a polyaminocarboxylic acid or salt thereof selected from the group of: methylglycine diacetic acid; nitrilotriacetic acid; glycinediacetic acid; ethylene diamine tetraacetic acid; iminodisuccinimide, and combinations thereof. The homogeneous detergent composition further comprises a nonionic surfactant present in an amount of from about 0.1 to about 10 parts by weight based on 100 parts by weight of the homogeneous detergent composition. The homogeneous detergent composition further comprises a silicate. The silicate comprises sodium silicate, sodium metasilicate, or combinations thereof and is present in an amount of from about 1 to about 45 parts by weight based on 100 parts by weight of the homogeneous detergent composition. The homogeneous detergent composition further comprises an enzyme. The enzyme comprises amylase, protease, or combinations thereof, and is present in an amount of from about 0.01 to about 10 parts by weight based on 100 parts by weight of the homogeneous detergent composition. The homogeneous detergent composition has a viscosity of from about 19,000 to about 750,000 cPs at 25° C.

The homogeneous detergent composition comprises both liquid and solid raw materials. The homogeneous detergent composition is typically manufactured by combining all of the solid raw materials. The solid raw materials are typically provided as a fine powder. When the solid raw materials are not provided as a fine powder, the solid raw materials are generally ground down to achieve a fine powder. Methods of grinding powders are understood in the art. The liquid raw materials are mixed together and heated to a temperate of about 25 to about 60° C. The solid raw materials are added the liquid raw materials and thoroughly mixed to produce the homogeneous detergent composition. Various vessels, mixers, blenders, and similar machinery understood in the art can be employed. After mixing, the homogeneous detergent composition is allowed to cool. If the homogeneous detergent composition includes an enzyme, the enzyme is added after the homogeneous detergent composition is allowed to cool to less than 40° C. The homogeneous detergent composition is not limited to any particular method of manufacturing. Conventional methods and apparatuses can be employed.

The present disclosure also provides a detergent packet. The detergent packet comprises a water soluble packet. The water soluble packet defines a cavity. The homogeneous detergent composition is disposed in the cavity. Typically a majority to an entirety of the cavity is filled with the homogeneous detergent composition.

Typically, the water soluble packet is made by forming a water soluble sheet or film. As known in the art, the water soluble packet may also be referred to as a pouch or sachet. Various methods are known in the art for making water soluble films. The water soluble sheet or film materials are typically flexible.

The water soluble packet may be formed from various polymers. Typically, the polymers are selected from the group of polyvinyl alcohols, polyvinyl alcohol copolymers, partially hydrolyzed polyvinyl acetates, cellulose derivatives (such as alkylcelluloses, hydroxyalkylcelluloses, salts, ethers and esters of alkylcelluloses and hydroxyalkylcelluloses, for example, hydroxypropylcellulose, hydroxypropylmethylcellulose and sodium carboxymethylcellulose) polyglycolides, polyglycolic acids, polylactides, polylactic acids; polyvinyl pyrrolidines, polyacrylic acids or salts or esters thereof, polymaleic acids or salts or esters thereof, dextrins, maltodextrins, polyacrylamides, acrylic acid/maleic anhydride copolymers, including copolymers (which includes many polymer forms such as terpolymers, block copolymer, etc.), and blends. Optionally fillers, plasticizers and process aids may also be included in the formulation of a water soluble packet for use herein. In a specific embodiment, the water soluble packet comprises polyvinyl alcohol.

Typically, the water soluble packet is fully dissolved during a typical dishwasher cleaning cycle. In other words, after the completion of the dishwasher cycle, no visible remnants of the water soluble packet remain in the dishwasher.

The homogeneous detergent composition is disposed in the cavity of the water soluble detergent packet. The homogeneous detergent composition generally does not adversely affect the water soluble packet. An example of an adverse affect is the dissolution of the water soluble packet such that a rupture of the water soluble packet occurs (i.e., one or more holes are formed in the water soluble packet which would permit the homogeneous detergent composition to flow out of the water soluble packet). In other words, the detergent packet that comprises the water soluble packet and the homogeneous detergent composition is storage stable under room temperature conditions for a period of six months. Another example of an adverse affect is crosslinking of the water soluble packet which could result from a non-compatible ingredient (i.e., an ingredient in the homogeneous detergent composition which crosslinks the water soluble packet). A water soluble packet which has crosslinked will dissolve very slowly or not all during a wash cycle of a dishwasher.

Conventional detergent formulations which are not homogeneous and contain solvent have a tendency to phase separate. More specifically, during phase separation water and/or solvent contained in the conventional detergent formulation migrates away from the raw materials contained in the conventional detergent formulation. Consequently, if such a conventional detergent formulation was disposed in the cavity of the water soluble packet, the phase separation would adversely affect the water soluble packet. Conversely, the homogeneous detergent formulation of the present disclosure is homogeneous and thus generally does not adversely affect the water soluble packet. In other words, the homogeneous detergent composition is stable and generally does not phase separate, such that the homogeneous detergent composition of this disclosure does not adversely affect the water soluble packet.

The following examples, illustrating the homogeneous detergent composition of the present disclosure are intended to illustrate and not to limit the disclosure.

### Examples

Various formulations of the homogeneous detergent composition are evaluated to determine spotting, filming, detergency and rheological properties. The various formulations (expressed in raw material weight percent based on total weight of the homogeneous detergent composition) are set forth below in Table 1 and 2. The manner in which the formulations are mixed is provided in Table 3. The results of the filming and spotting are also set forth below. The results of the detergency and rheological properties are briefly described below and set forth in greater detail in the Figures.

TABLE 1

| | Formulation | | | | |
|---|---|---|---|---|---|
| Raw Material | 1 | 2 | 3 | 4 | 5 |
| Polycarboxylate 1 | 2.9 | 2.9 | 0 | 0 | 0 |
| Polycarboxylate 2 | 0 | 0 | 6 | 6 | 0 |
| Polycarboxylate 3 | 0 | 0 | 0 | 0 | 0 |
| Alkalinity builder | 41 | 41 | 41 | 41 | 41 |
| Solvent 1 | 3.1 | 3.1 | 0 | 0 | 6 |
| Solvent 2 | 18 | 18 | 18 | 18 | 18 |
| Chelating agent | 18 | 18 | 18 | 18 | 18 |
| Additive 1 | 14 | 14 | 14 | 14 | 14 |
| Additive 2 | 2 | 2 | 2 | 2 | 2 |
| Additive 3 | 1 | 1 | 1 | 1 | 1 |

TABLE 2

| | Formulation | | | | | | |
|---|---|---|---|---|---|---|---|
| Raw Material | 6 | 7 | 8 | 9 | 10 | 11 | 12 |
| Polycarboxylate 1 | 2.9 | 0 | 0 | 0 | 0 | 0 | 0 |
| Polycarboxylate 2 | 0 | 6.0 | 6.0 | 0 | 0 | 0 | 0 |
| Polycarboxylate 3 | 0 | 0.0 | 0.0 | 6.0 | 5.1 | 7.5 | 0 |
| Alkalinity builder | 41 | 40.8 | 40.8 | 41 | 51.9 | 50.5 | 43.7 |
| Solvent 1 | 2.8 | 0.0 | 0.0 | 0 | 0 | 0 | 0 |
| Solvent 2 | 18 | 17.9 | 17.9 | 19 | 0 | 0 | 20.1 |
| Chelating agent | 18 | 17.9 | 17.9 | 18 | 22.8 | 22 | 19.1 |
| Additive 1 | 14 | 13.9 | 13.9 | 14 | 17.7 | 17.5 | 15.1 |
| Additive 2 | 2 | 2.0 | 2.0 | 2 | 0 | 2.5 | 0 |
| Additive 3 | 0 | 1.0 | 1.0 | 0 | 2.5 | 0 | 0 |
| Additive 4 | 0.3 | 0.0 | 0.0 | 0 | 0 | 0 | 0 |
| Additive 5 | 1 | 0.0 | 0.0 | 0 | 0 | 0 | 0 |
| Additive 6 | 0 | 0.5 | 0.0 | 0 | 0 | 0 | 0 |
| Additive 7 | 0 | 0.0 | 0.5 | 0 | 0 | 0 | 0 |

Polycarboxylate 1 is the polymerization product of the sulfonic acid acrylate and acrylic acid.

Polycarboxylate 2 is the polymerization product of acrylic acid.

Polycarboxylate 3 is the polymerization product of maleic acid and diisobutene.

Solvent 1 is water.

Solvent 2 is glycerine.

Chelating agent is a granular polyaminocarboxylic acid and commercially available from the BASF Corporation.

Additive 1 is an aqueous alkali silicate containing approximately 47% alkali silicate and approximately 53% water.

Additive 2 is a nonionic surfactant commercially available from BASF Corporation.

Additive 3 is an enzyme commercially available from Genencor.

Additive 4 is an enzyme commercially available from Univar.

Additive 5 is an enzyme commercially available from Novozymes.

Additive 6 is a block copolymer surfactant commercially available from BASF Corporation.

Additive 7 is alkyl polyglycoside surfactant commercially available from BASF Corporation.

TABLE 3

| For- | | |
|---|---|---|
| mula- | Solid Raw Material | Solid and Liquid Raw Material |
| tion | Mixing | Mixing |
| 1 | Materials were weighed | Materials were mixed with an over- |
| | together, but not | head mixer using a propeller-type |
| | thoroughly mixed | blade over low heat (<50° C.) until |
| | | homogeneous |
| 2 | Materials were ground into | Materials were mixed with an over- |
| | a fine powder using an | head mixer using a propeller-type |
| | Oster 10-speed blender | blade over low heat (<50° C.) until |
| | | homogeneous |
| 3 | Materials were weighed | Materials were mixed with an over- |
| | together, but not | head mixer using a propeller-type |
| | thoroughly mixed | blade until homogeneous |
| 4 | Materials were weighed | Materials were mixed with an over- |
| | together, but not | head mixer using a propeller-type |
| | thoroughly mixed | blade until homogeneous |
| 5 | Materials were weighed | Materials were mixed with an over- |
| | together, but not | head mixer using a propeller-type |
| | thoroughly mixed | blade until homogeneous |
| 6 | Materials were ground into | Materials were mixed with an over- |
| | a fine powder using an | head mixer using a propeller-type |
| | Oster 10-speed blender | blade until homogeneous |
| 7 | Materials were ground into | Materials were mixed with an over- |
| | a fine powder using an | head mixer using a propeller-type |
| | Oster 10-speed blender | blade over low heat (<50° C.) until |
| | | homogeneous |
| 8 | Materials were ground into | Materials were mixed with an over- |
| | a fine powder using an | head mixer using a propeller-type |
| | Oster 10-speed blender | blade over low heat (<50° C.) until |
| | | homogeneous |
| 9 | Materials were added to a | Materials were mixed with an over- |
| | jar with a minimum of 30% | head mixer using a propeller-type |
| | head space. The jar was | blade over low heat (<50° C.) until |
| | sealed tightly and rolled | homogeneous |
| | for a minimum of 20 | |
| | minutes | |
| 10 | Materials were added to a | Materials were mixed with an over- |
| | jar with a minimum of 30% | head mixer using a propeller-type |
| | head space. The jar was | blade over low heat (<50° C.) until |
| | sealed tightly and rolled | homogeneous |
| | for a minimum of 20 | |
| | minutes | |
| 11 | None | Materials were weighed batch-wise |
| | | into beakers and placed directly into |
| | | the dishwasher during performance |
| | | testing |
| 12 | None | Materials were weighed batch-wise |
| | | into beakers and placed directly into |
| | | the dishwasher during performance |
| | | testing |

Formulations 1 and 3 are evaluated for spotting. Formulation 1, 3, and 9-12 are evaluated for filming. Six drinking glasses are prepared for each experiment by thorough washing, drying and visual inspection to assure completely spot and streak-free starting conditions. The dishwasher is prepared by running one cleaning load with no soil using citric acid, phosphate detergent, and city water to remove any soil from the previous testing. A single rinse cycle with no detergent or hard water is performed to flush the system and prevent carryover of detergent or dilution of the hard water during testing.

After preparing both the dish washer and six drinking glasses the six drinking glasses are placed in the upper rack of the dishwasher. In the bottom rack, to simulate home use conditions, six nine-inch chinaware plates and six six-inch plates are placed in alternate positions. In a separate holder, six knives, six forks, and six teaspoons are placed to simulate home use conditions. In subsequent washing cycles the glasses are rotated a quarter turn in position to eliminate spray-pattern effects of the dishwasher. The test is started with a warm machine and run for three consecutive cycles, with the following soil loads and detergent/rinse aid dosing: 1st cycle—20 grams of detergent, or one unit dose tablet, in main wash cup; 40 grams of fat soil on one of the six inch plates in the prewash; 2nd cycle—20 grams of detergent, or one unit dose tablet, in main wash cup; 40 grams of fat soil (1) on one of the six inch plates in the prewash; 12 grams powdered milk in a beaker in the main wash (bottom rack); 3rd cycle—20 grams of detergent, or one unit dose tablet, in main wash cup; 40 grams of fat soil (1) on one of the six inch plates in the prewash; 15 grams blended raw egg in a beaker in the main wash (bottom rack). The performance of the detergent is evaluated by visually rating the drinking glasses (using the Light Box in a dark room to compare against established standards) after three full cycles on a scale from 1.0 to 5.0 covering the range from perfectly free of spots and filming to completely covered with spots, streaks and/or haze.

| Spotting | Rating |
|---|---|
| none | 1.0 |
| spots at random | 1.5 |
| ¼ of surface spotted | 2.0 |
| ½ of surface spotted | 3.0 |
| ¾ of surface spotted | 4.0 |
| totally spotted | 5.0 |

| Filming/Streaking | Rating |
|---|---|
| none | 1.0 |
| barely perceptible | 1.5 |
| slight | 2.0 |
| moderate | 3.0 |
| heavy | 4.0 |
| very heavy | 5.0 |

TABLE 4

Formulation

| Test | 1 | 3 |
|---|---|---|
| Spotting | 1.5 | 1.5 |

TABLE 5

Formulation

| Test | 9 | 10 | 11 | 12 | 1 | 3 |
|---|---|---|---|---|---|---|
| Filming | 4.5 | 4.5 | 4 | 4.25 | 1 | 1.625 |

Formulation 2, 4, and 6 are evaluated for detergency. Soiled monitors from the Center for Test Materials are evaluated using a Konica Minolta colorimeter prior to washing. Two monitors each of colored mixed starch (DM-77), tea (DM-11), double soiled minced meat (DM-92) and egg yolk (DM-21) soils are examined in 3 places to determine coordinates in L*,a*,b* color space.

The dishwashers are prepared between each test by cleaning the filters thoroughly, running one cycle with 25 g of citric acid, rinsing using city water and charging the lines with 300 ppm water.

The monitors are positioned evenly in the dishwasher so that one of each monitor is in each rack. The dishwasher is set to the 1-hour wash cycle with heat dry option using 300 ppm manually hardened water and the main wash cup is closed. When the main wash cup opens (12 minutes and 30 seconds into the wash cycle), the door is opened and a 150 ml beaker containing 20 g of detergent is inverted in the front, right position of the top rack. The cycle is then resumed.

After the cycle is complete, the monitors are removed and examined, as before, using the Konica Minolta colorimeter. The change in L*, a*, and b* positions are calculated and compared to a perfectly clean monitor to determine the percent clean of each panel.

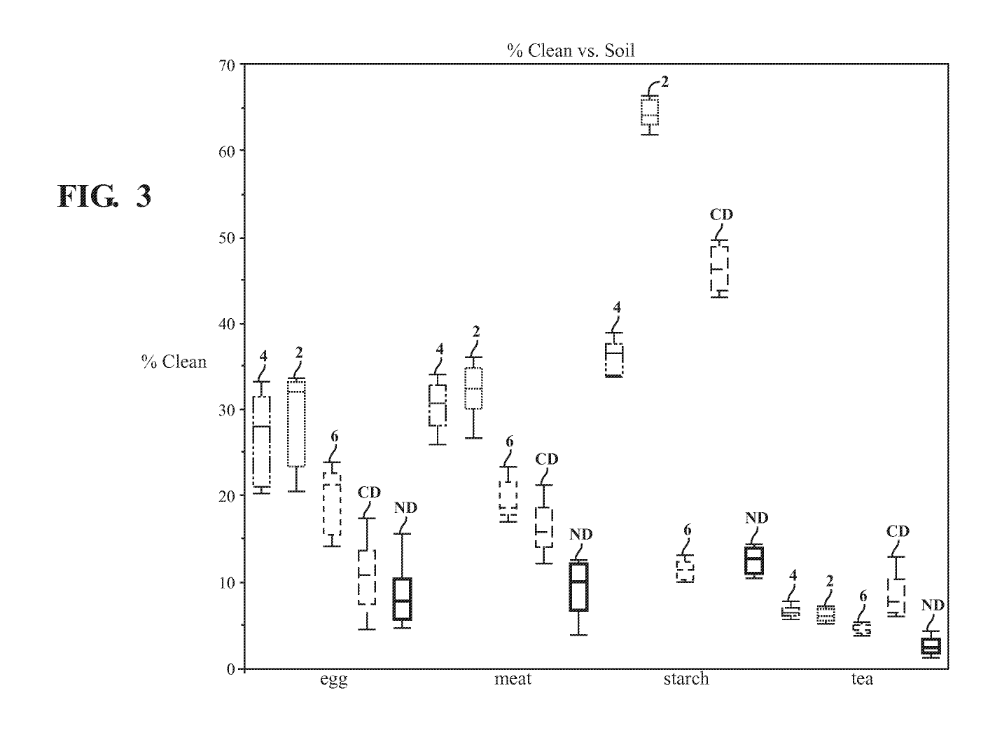

The detergency examines the percent cleaning on samples soiled with egg, meat, starch, and tea. Included with the samples is a blank (i.e., an evaluation without detergent) and a conventional dishwasher detergent for comparison purposes. The results of the detergency test are shown in FIG. 3. The conventional detergent is labeled as CD, and the blank is labeled as ND.

The results from the filming, spotting, and detergency testing indicate the Formulations have excellent cleaning properties.

The viscosity of Formulations 1-10 is measured with an Anton Paar Physica MCR 301 rheometer having Rheoplus Software. The viscosity is measured by inserting a PP50 measuring spindle into the instrument. The zero gap is calibrated using Rheoplus. With the spindle in the ‘lift’ position, approximately 3 ml of sample is loaded onto the platform. The spindle is moved to the ‘measurement’ position and excess sample is trimmed from the edges of the spindle. The viscosity is measured at a shear rate of 100 sec⁻¹ at 25° C. The results of the viscosity measurement are shown in FIG. 1. Notably, the numerals in FIGS. 1-3 correspond to Formulations 1-10. The results indicate that Formulations 1-10 are highly viscous.

The viscosity of Formulations 1-10 is also evaluated for temperature dependence and thixotropy. The temperature dependence and thixotropy evaluation is conducted with an Anton Paar Physica MCR 301 rheometer with Rheoplus Software is used to evaluate rheology. A PP50 measuring spindle is inserted into the instrument. The zero gap is calibrated using Rheoplus. With the spindle in the ‘lift’ position, approximately 3 ml of sample is loaded onto the platform. The spindle is then moved to the ‘measurement’ position and excess sample is trimmed from the edges of the spindle. The viscosity at a constant shear rate of 100 sec⁻¹ is evaluated at 25 and at 40° C. for 5 minutes each and provided in FIG. 1A and FIG. 1B.

The temperature dependence is further evaluated at a constant sheer rate of 10 sec-1 using a program beginning at 20° C. and increasing in 5° C. increments, holding for 2 minutes at each temperature, to a maximum temperature of 40° C. After holding at the maximum temperature for 2 minutes, the temperature decreases in 5° C. increments, holding for 2 minutes at each temperature, to a minimum of 20° C. Four viscosity measurements are taken at each step.

The results of the temperature dependence and thixotropy are displayed in FIGS. 1 and 2. Notably, the numerals in FIGS. 1-2 correspond to Formulations 1-10. The results indicate that the viscosity of the Formulations is both thixotropic and temperature dependent. More specifically, the results indicate that small changes in temperature have a large impact on the viscosity of the formulations. Moreover, the selection of the solvent, amount of solvent, the choice of polycarboxylate, and both the choice of alkalinity builder and particle size of the alkalinity builder and other solid raw materials, contained within the formulations generally manipulates the viscosity of the formulations.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present disclosure independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present disclosure, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present disclosure has been described in an illustrative manner, and it is to be understood that the terminology which has been used is intended to be in the nature of words of description rather than of limitation. Many modifications and variations of the present disclosure are possible in light of the above teachings. The present disclosure may be practiced otherwise than as specifically described. The subject matter of all combinations of independent and dependent claims, both singly and multiply dependent, is herein expressly contemplated.

1. A homogeneous detergent composition comprising:
an alkalinity builder present in an amount of at least about 35 parts by weight based on 100 parts by weight of said homogeneous detergent composition;
a polycarboxylate for dispersing said alkalinity builder wherein said polycarboxylate is selected from the group of,
a polymerization product of a sulfonic acid acrylate and acrylic acid,
a polymerization product of acrylic acid, maleic acid, and an allyl ether,
a polymerization product of acrylic acid and isopropyl alcohol,
a polymerization product of maleic acid and diisobutene,
a polymerization product of acrylic acid, methacrylic acid and an ionic monomer of the Formula (I), 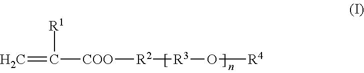
wherein in Formula (I), R¹ is hydrogen or a methyl group, R² is a linear or branched C1-C6 alkylene, each R³ is individually a linear or branched C2-C4 alkylene radical, R⁴ is a linear or branched C1-C6 alkyl, and n is an integer of from 3 to 50,
and combinations thereof; and
a solvent for further dispersing said alkalinity builder and present in an amount of from about 20 to about 45 parts by weight based on 100 parts by weight of said homogeneous detergent composition;
wherein said homogeneous detergent composition has a viscosity of at least about 15,000 cPs at 25° C.

2. The homogeneous detergent composition as set forth in claim 1 having a viscosity of from about 19,000 to about 750,000 cPs at 25° C.

3. The homogeneous detergent composition as set forth in claim 1 further comprising a nonionic surfactant present in an amount of from about 0.1 to about 10 parts by weight based on 100 parts by weight of said homogeneous detergent composition.

4. The homogeneous detergent composition as set forth in claim 1 further comprising a chelating agent in an amount of from about 1 to about 45 parts by weight based on 100 parts by weight of said homogeneous detergent composition.

5. The homogeneous detergent composition as set forth in claim 4 wherein said chelating agent comprises a polyaminocarboxylic acid or salt thereof selected from the group of methylglycine diacetic acid, nitrilotriacetic acid, glycinediacetic acid, ethylene diamine tetraacetic acid, iminodisuccinimide, and combinations thereof.

6. The homogeneous detergent composition as set forth in claim 1 further comprising a silicate wherein
said silicate comprises sodium silicate, sodium metasilicate, or a combination thereof.

7. The homogeneous detergent composition as set forth claim 1 further comprising an enzyme present in an amount of from about 0.01 to about 10 parts by weight based on 100 parts by weight of said homogeneous detergent composition.

8-14. (canceled)

15. The homogeneous detergent composition as set forth in claim 1 wherein said solvent comprises water, glycerine, or a combination thereof.

16. The homogeneous detergent composition as set forth in claim 1 wherein said alkalinity builder comprises sodium carbonate.

17. A homogeneous detergent composition comprising:
an alkalinity builder comprising sodium carbonate and present in an amount of at least about 35 parts by weight based on 100 parts by weight of said homogeneous detergent composition;
a polycarboxylate for dispersing said alkalinity builder, said polycarboxylate selected from the group of;
i) a polymerization product of acrylic acid and having a weight average molecular weight of from about 2,000 to about 20,000,
ii) a polymerization product of a sulfonic acid acrylate and acrylic acid,
iii) a polymerization product of acrylic acid, maleic acid, and an allyl ether,
iv) a polymerization product of acrylic acid and isopropyl alcohol,
v) a polymerization product of maleic acid and diisobutene, and
vi) a polymerization product of acrylic acid, methacrylic acid, and an ionic monomer of the Formula I 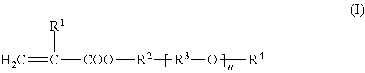
wherein in Formula (I), R¹ is hydrogen or methyl group, R² is a linear or branched C1-C6 alkylene, each R³ is individually a linear or branched C2-C4 alkylene radical, R⁴ is a linear or branched C1-C6 alkyl, and n is an integer of from 3 to 50;
a solvent for further dispersing said alkalinity builder, said solvent comprising water, glycerine, or a combination thereof and present in an amount of from about 20 to about 45 parts by weight based on 100 parts by weight of said homogeneous detergent composition;
a chelating agent present in an amount of from about 1 to about 45 parts by weight based on 100 parts by weight of said homogeneous detergent composition and comprising a polyaminocarboxylic acid or salt thereof selected from the group of;
i) methylglycine diacetic acid,
ii) nitrilotriacetic acid,
iii) glycinediacetic acid,
iv) ethylene diamine tetraacetic acid,
v) iminodisuccinimide, and
vi) combinations thereof;
a nonionic surfactant present in an amount of from about 0.1 to about 10 parts by weight based on 100 parts by weight of said homogeneous detergent composition;
a silicate comprising sodium silicate, sodium metasilicate, or combinations thereof and present in an amount of from about 1 to about 45 parts by weight based on 100 parts by weight of said homogeneous detergent composition; and
an enzyme comprising amylase, protease, or combinations thereof, and present in an amount of from about 0.01 to about 10 parts by weight based on 100 parts by weight of said homogeneous detergent composition;
wherein said homogeneous detergent composition has a viscosity of from about 19,000 to about 750,000 cPs at 25° C.

18. A detergent packet comprising:
a water soluble packet defining a cavity; and
a homogeneous detergent composition disposed in said cavity and comprising;
an alkalinity builder present in an amount of at least about 35 parts by weight based on 100 parts by weight of said homogeneous detergent composition,
a polycarboxylate for dispersing said alkalinity builder wherein said polycarboxylate is selected from the group of,
a polymerization product of a sulfonic acid acrylate and acrylic acid,
a polymerization product of acrylic acid, maleic acid, and an allyl ether,
a polymerization product of acrylic acid and isopropyl alcohol,
a polymerization product of maleic acid and diisobutene,
a polymerization product of acrylic acid, methacrylic acid and an ionic monomer of the Formula (I), 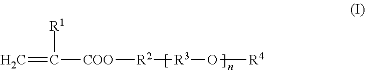
wherein in Formula (I), R¹ is hydrogen or methyl group, R² is a linear or branched C1-C6 alkylene, each R³ is individually a linear or branched C2-C4 alkylene radical, R⁴ is a linear or branched C1-C6 alkyl, and n is an integer of from 3 to 50,
and combinations thereof; and
a solvent for further dispersing said alkalinity builder and present in an amount of from about 20 to about 45 parts by weight based on 100 parts by weight of said homogeneous detergent composition;
wherein said homogeneous detergent composition has a viscosity of at least about 15,000 cPs at 25° C.

19. The detergent packet as set forth in claim 18 wherein said water soluble packet comprises polyvinyl alcohol.

20. (canceled)

21. The detergent packet as set forth in claim 18 wherein said homogeneous detergent composition further comprises a nonionic surfactant present in an amount of from about 0.1 to about 10 parts by weight based on 100 parts by weight of said homogeneous detergent composition.

22. The detergent packet as set forth in claim 18 wherein said homogeneous detergent composition further comprises a chelating agent in an amount of from about 1 to about 45 parts by weight based on 100 parts by weight of said homogeneous detergent composition.

23. The detergent packet as set forth in claim 18 wherein said chelating agent comprises a polyaminocarboxylic acid or salt thereof selected from the group of methylglycine diacetic acid, nitrilotriacetic acid, glycinediacetic acid, ethylene diamine tetraacetic acid, iminodisuccinimide, and combinations thereof.

24. The detergent packet as set forth in claim 18 wherein said homogeneous detergent composition further comprises a silicate wherein:
said silicate is present in an amount of from about 1 to about 45 parts by weight based on 100 parts by weight of said homogeneous detergent composition; and/or
said silicate comprises sodium silicate, sodium metasilicate, or a combination thereof.

25. The detergent packet as set forth in claim 18 wherein said homogeneous detergent composition further comprises an enzyme present in an amount of from about 0.01 to about 10 parts by weight based on 100 parts by weight of said homogeneous detergent composition.

26. The homogeneous detergent composition as set forth in claim 1 wherein said polycarboxylate comprises a polymerization product of a sulfonic acid acrylate and acrylic acid having a weight average molecular weight of from about 2,000 to about 20,000.

27. The homogeneous detergent composition as set forth in claim 1 further comprising a silicate in an amount of from about 1 to about 45 parts by weight based on 100 parts by weight of said homogeneous detergent composition.

28. The homogeneous detergent composition as set forth in claim 1 further comprising a nonionic surfactant selected from the group of alkylphenol alkoxylates, alcohol alkoxylate, alkyl polyglucosides, hydroxyalkyl polyglucosides, hydroxyl mixed ether, N-alkylglucamides, alkylene oxide block copolymers, polyhydroxy and polyalkoxy fatty acid derivatives, and combinations thereof.

29. The homogeneous detergent composition as set forth in claim 17 wherein said polycarboxylate comprises a polymerization product of a sulfonic acid acrylate and acrylic acid having a weight average molecular weight of from about 2,000 to about 20,000.

30. The homogeneous detergent composition as set forth in claim 17 wherein said nonionic surfactant is selected from the group of alkylphenol alkoxylates, alcohol alkoxylate, alkyl polyglucosides, hydroxyalkyl polyglucosides, hydroxyl mixed ether, N-alkylglucamides, alkylene oxide block copolymers, polyhydroxy and polyalkoxy fatty acid derivatives, and combinations thereof.
